(19) United States
(12) Patent Application Publication
(10) Pub. No.: US 2009/0181246 A1
(43) Pub. Date: Jul. 16, 2009

(54) POLYPROPYLENE COMPOSITE

(75) Inventors: Paul D. Cowan, Pinckney, MI (US); Hiroshi Inanami, Ann Arbor, MI (US); Enrique O. Iriarte, Sidney, OH (US); Toru Fukada, Sidney, OH (US); Frank E. Jones,, III, Nashville, TN (US)

Correspondence Address: GIFFORD, KRASS, SPRINKLE,;ANDERSON & CITKOWSKI, P.C., P.O. BOX 7021, TROY, MI, 48007-7021, US

(73) Assignees: Toyota Motor Engineering & Manufacturing North America, Inc., Erlanger, KY (US); Advanced Composites Inc., Sidney, OH (US)

(21) Appl. No.: 12/245,795

(22) Filed: Oct. 6, 2008

Related U.S. Application Data
(60) Provisional application No. 61/020,502, filed on Jan. 11, 2008.

(51) Int. Cl. B32B 27/16; B32B 27/32

(52) U.S. Cl. 428/338; 428/523

(57) ABSTRACT

A polypropylene composite that includes 50 to 75 weight percent of polypropylene resin based on the weight of the polypropylene composite. The polypropylene resin has a melt flow rate of from 20 to 300 at 230° centigrade under a 2.16 kilogram load. The polypropylene composite also includes from 5 to 15 weight percent based on the weight of the polypropylene composite of ethylene-alpha-olefin diene copolymer rubber. The ethylene-alpha-olefin diene copolymer rubber has a melt flow rate of less than 0.4 at 230° centigrade under a 2.16 kilogram load. Also included is from 5 to 15 weight percent of an ethylene-alpha-octene copolymer rubber having a melt flow rate of from 0.5 to 20 at 230° centigrade under a 2.16 kilogram load Also a ratio of ethylene-alpha-olefin diene copolymer rubber divided by a total content of ethylene-alpha-olefin diene copolymer rubber and ethylene-alpha-octene copolymer rubber is 0.35-0.45. Also included is from 20 to 25 weight percent based on the weight of the polypropylene composite of organic filler. Further included is from 0.1 to 5 weight percent based on the weight of the polypropylene composite of a grafted polypropylene and from 0.1 to 0.6 weight percent based on the weight of the polypropylene composite of a surface treatment material. The surface treatment material remains dispersed in the polypropylene composite preventing blooming of the surface treatment material when exposed to the environment.

### RELATED APPLICATION

This application claims priority of U.S. Provisional Patent Application Ser. No. 61/020,502 filed Jan. 11, 2008, which is incorporated herein by reference.

### FIELD OF THE INVENTION

The invention relates to polypropylene composite materials and components formed of the composite material having improved surface properties and stability.

### BACKGROUND OF THE INVENTION

It is generally known in the art that polypropylene may be injection molded to form components for use in automotive as well as other applications including appliances and other industries. Polypropylene may be chosen for such applications due to its desirable physical properties as well as moldability and relatively cheap cost.

It is known in the art that polypropylene may be combined with other materials to form a compound or composite to improve the physical properties of polypropylene. For example, polypropylene may be combined with elastomer compositions to improve the impact resistance of a material. Various elastomers such as ethylene propylene rubber, ethylene butene rubber, ethylene octene rubber, styrene butadiene rubber, polystyrene ethylene and butene polystyrene rubbers as well as others may be utilized. Additionally, polypropylene may be combined with inorganic reinforcement materials to improve the modulus of the polystyrene. Various inorganic reinforcements include talc, mica, glass fiber and other materials.

Due to the improvement of injection molding of polypropylene it is desirable to use such compositions where smooth surfaces may be required. For example, improvements in formation of injection molded components eliminating tiger striping and knit lines commonly displayed in components of an injection molding process. Typically, polypropylene materials have poor scratch resistance and high gloss requiring additional paint layers or skin layers applied to an outer surface of a polypropylene component. The addition of the layers or paint layers increases the cost of a component produced from a polypropylene material. There is therefore a need in the art for an improved polypropylene component that does not require an additional paint or skin layer.

Additionally, polypropylene composites known in the art display relatively poor scratch resistance, high gloss and poor weatherability resulting in blooming of various components within the composite to a surface causing a sticky surface as well as undesirable discoloration. There is therefore a need in the art for an improved polypropylene composite that has improved scratch resistance, desirable gloss properties as well as is stable when exposed to the environment.

### SUMMARY OF THE INVENTION

In one aspect there is disclosed a polypropylene composite that includes 50 to 75 weight percent of polypropylene resin based on the weight of the polypropylene composite. The polypropylene resin has a melt flow rate of from 20 to 300 at 230° centigrade under a 2.16 kilogram load. The polypropylene composite also includes from 5 to 15 weight percent based on the weight of the polypropylene composite of ethylene-alpha-olefin diene copolymer rubber. The ethylene-alpha-olefin diene copolymer rubber has a melt flow rate of less than 0.4 at 230° centigrade under a 2.16 kilogram load. Also included is from 5 to 15 weight percent of an ethylene-alpha-octene copolymer rubber having a melt flow rate of from 0.5 to 20 at 230° centigrade under a 2.16 kilogram load. A ratio of ethylene-alpha-olefin diene copolymer rubber divided by a total content of ethylene-alpha-olefin diene copolymer rubber and ethylene-alpha-octene copolymer rubber is 0.35-0.45. Also included is from 20 to 25 weight percent based on the weight of the polypropylene composite of organic filler. Further included is from 0.1 to 5 weight percent based on the weight of the polypropylene composite of a grafted polypropylene and from 0.1 to 0.6 weight percent based on the weight of the polypropylene composite of a surface treatment material. The surface treatment material remains dispersed in the polypropylene composite preventing blooming of the surface treatment material when exposed to the environment.

### BRIEF DESCRIPTION OF THE DRAWINGS

FIG. 1 is a graph of the absorbance spectrum of one example of a surface treatment material;

FIG. 2 is a plot of the appearance of a composite material having a surface treatment in comparison to untreated and comparable materials when exposed to Xenon at various energy levels.

### DETAILED DESCRIPTION OF THE PREFERRED EMBODIMENTS

In one aspect, the polypropylene composite includes from 50 to 75 weight percent of a polypropylene resin, 5 to 15 weight percent of an ethylene-alpha-olefin diene copolymer rubber, 5 to 15 weight percent of an ethylene-alpha-octene copolymer rubber, 15 to 30 weight percent of an inorganic filler, 0.1 to 5 weight percent of a grafted polypropylene, and 0.1 to 1.0 weight percent of a surface treatment material. All of the weight percents are based on the weight of the polypropylene composite. The surface treatment material remains dispersed in the polypropylene composite preventing blooming of the surface treatment material when exposed to the environment.

In one aspect, the polypropylene resin which is present in an amount of from 50 to 75 weight percent has a melt flow rate of from 200 to 300 at 230° centigrade under a 2.16 kilogram load. In another aspect, the melt flow rate may range from 50 to 250 under the same conditions described above. The polypropylene resin may be a homopolymer or may be a polypropylene ethylene block copolymer. When a polypropylene ethylene block copolymer is utilized, the copolymer preferably has an n-deca insoluble weight percent range of from 5 to 15 and preferably from 7 to 13.

The ethylene-alpha-olefin diene copolymer rubber may have a melt flow rate less than 0.4 and preferably from 0.05 to 0.35 at 230° centigrade under a 2.16 kilogram load. Additionally, the ethylene-alpha-olefin diene copolymer preferably has a molecular weight range of from 2.0×105 to 5.0×105 based on GPC measurements. Preferably, the molecular weight range may be from 2.3×105 to 3.0×105. It has been found that the molecular weight of less than 2.0×105 may result in molded products having higher than desirable gloss. Additionally, molecular weight ranges greater than 5.0×105 may have undesirable properties resulting in lower impact resistance of a molded component.

In one aspect, the alpha-olefin of the ethylene-alpha-olefin diene copolymer rubber may include from 3 to 10 carbons. Preferably, the alpha-olefin may be selected from propylene, 1 butene, 1 hexene, and 1 octene. In another aspect, the diene component of the ethylene-alpha-olefin diene copolymer rubber may be selected from materials including 5-ethylidene-2-norbornene, 5-polypylidene-2-norbornene, dicylo-pentadiene, 5-vinyl-2-norbornadiene, 5-methylene-2-norbornadiene, cyclic-non-conjugated-dienes, 1,4-hexa-diene, 4-methyl-1,4-hexadiene, 5-methyl-1, 4hexadiene, 5-methyl-1,5-heptadiene, 6-methy-1,5-heptadiene, 6-methyl-1, 7-octadiene, 7-methyl-1,6octadiene, and cyclic-conjugated-dienes. In another aspect, the viscosity of the ethylene-alpha-olefin diene copolymer may preferably be from 2.0 to 2.4 decaliters per gram at 23° centigrade.

In one aspect, the ethylene-alpha-octene copolymer rubber may have a melt flow range of from 0.5 to 20 and even more preferably of from 1.5 to 10 at 230° centigrade under a 2.16 kilogram load. In another aspect, the ethylene-alpha-octene copolymer rubber may have a molecular weight ranging from 0.5×105 to 2.0×105 and preferably from 10×105 to 1.8×105 based on GPC measurement. Additionally, the ethylene-alpha-octene copolymer rubber may have a viscosity of from 1.0 to 2.0 decaliters per gram at 23° centigrade

In one aspect, the polypropylene composite may have a ratio of ethylene-alpha-olefin diene copolymer rubber to ethylene-alpha-octene copolymer rubber may be 25 to 75 weight percent and preferably from 40 to 55 weight percent based on a total weight of the copolymer rubbers. In another aspect, the ratio of ethylene-alpha-olefin diene copolymer rubber divided by a total content of ethylene-alpha-olefin diene copolymer rubber and ethylene-alpha-octene copolymer rubber may be 0.35-0.45.

Inorganic fillers that may be utilized by the invention include talc, mica, calcium carbonate, barium sulfate, glass fibers, gypsum, magnesium carbonate, magnesium oxide, titanium oxide, iron oxide, zinc, copper, iron, aluminum and other metal powders, as well as inorganic fibers. In one aspect, talc may be preferably utilized in the composite and may have an average diameter ranging from 1 to 15 micrometers and even more preferably 1 to 6 micrometers.

The grafted polypropylene material utilized in the composite may include a hydride acid. In one aspect, the hydride acid may be maleic anhydride. The maleic anhydride may be present in an amount of from 0.8 to 2.0 weight percent based upon a total weight of the polypropylene composite. The modified polypropylene may be included in the composite to act as an anti-scratch additive. Addition of modified polypropylene less than 0.1 weight percent may result in no improvement of scratch resistance while amounts greater than 5 weight percent may result in lessening of an impact resistance of a composite material.

The surface treatment materials that may be utilized in the polypropylene composite include fatty acid amides. Various fatty acid amides that may be utilized by the invention include oleic amide, stearic amide, erucic amide, behenic amide, palmitic amide, myrystic amide, lauric amide, caprylic amide, n-oreic-parmit-amide, n-oreic-eruic amide or combinations thereof. The fatty acid amide may be present in an amount of from 0.1 to 1.0 weight percent based upon a total weight percent of the polypropylene composite. Preferably, the surface treatment material may be present in an amount of from 0.1 to 0.5 weight percent based upon a total weight percent of the polypropylene composite.

In one aspect, a component made from the polypropylene composite of the invention may be positioned under UV glass. For example, the polypropylene composite material may be utilized to form an instrument panel which is positioned inside and under a UV glass windshield of an automobile. Typically, UV cut glass that may be utilized in an automobile has a characteristic to absorb UV light of a short frequency of from about 350 nanometers and preferably less than 390 nanometers. The polypropylene composite of the present invention displays stability when positioned under UV cut glass such that the surface treatment material of the polypropylene composite when exposed to the environment does not bloom to the surface of the composite material. Additionally, the polypropylene composite may display low gloss and high scratch resistance in comparison to prior art polypropylene composite materials.

In another aspect other additives such as, heat stabilizer, anti-static additive, anti-weatherability additive, anti-light-additive, anti-aging, anti-oxidation additive, fatty acid metal, plasticizer, dispersion additive, filler, pigment, slip additive, colorant and others can be used. The polypropylene composite may be produced using various types of equipment, such as a banbury mixer, single screw extruder, twin screw extruder, and high speed twin screw extruder.

### EXAMPLES

Example Data

This invention is not limited by the following examples.

The following is the test methodology for each of the characteristics of the composite.

Melt flow rate (g/10 mion)

Based on ASTM D1238, under the condition, weight: 2.16 kg, examination temperature: 230 deg C., so called MFR

Flexural modulus (MPa)

Based on ASTM D790, under the condition, span: 100 mm, bending speed: 2 mm/min

Izod impact at room temp (J/m)

Based on ASTM D256, under the condition, Notched T/P, hammer weight: 40 kgcm

Glass fogging (%)TSM0503G -3.2

Tested glass fogging

Test condition: 100 deg C., oil bath, 24 hours

Test plaques size: 25 mm*100 mm*2 mm (thickness)

Test method: Test specimen is placed into a glass bottle. Submerge the glass bottle 110 mm into the oil bath. The glass bottle must be sealed with the test panel. Oil bath temperature must be regulated for 24 hrs@100 deg C.

Test Results: Take out test panel and measure its quantity of incoming light.

Milled gloss ASTM D523

Testing gloss on milled plaque surface which is molded under the following conditions; Injection temperature: 210 deg C.,

Tool temperature: 40 deg C., 120 mm*130 mm*2 mm (thickness), milled plaque.

Gloss meter: Nihondenshoiukougyo.KK, NDH-300@60 degree.

Test Method: Measure gloss on milled plaque using gloss meter@60 degree

Scratch resistance I Ford 5 Finger Test

Testing scratch resistance on a plaque molded under the following conditions;

Injection temperature: 210 deg C.

Tool temperature: 40 deg C., 120 mm*130 mm*2 mm (thickness), Grain C plaque.

Test machine: Ford 5-Finger Test (N)

Test method: Place test plaque on machine. Select desired weights and place on apparatus. Place 5 fingers (with weights (N)) on plaque and start the test.

Test Results: Evaluate max N which whitening is not seen.

Scratch resistance 2 Tungsten

Testing scratch resistance on a plaque molded under the following conditions:

Injection temperature: 210 deg C.

Tool temperature: 40 deg C., 120 mm*130 mm*2 mm (thickness), Grain C plaque.

Test machine: Tungsten needle, 35 g

Test method: Evaluate Place 35 g weight on test machine. Place the plaque on the test machine and begin the test.

Test Results: Check DE between blank and scratched portion of tested plaque

Weatherability 1 (TSM0501G)

Testing xenon-arc on a plaque molded under the following molding conditions;

Injection temperature: 210 deg C., tool temperature: 40 deg C., 120 mm*130 mm*2 mm(thickness), grain GRO34,

Exposure length: 2065 kJ/m2, black panel temperature 89 deg C.

Test Method: Once exposed, check DE & Micro-crack.

Weatherability 2(TSMO501G)

Testing xenon-arc on a plaque molded under the following molding conditions;

Injection temperature: 210 deg C.

Tool temperature: 40 deg C., 120 mm*130 mm*2 mm(thickness), grain GR034,

Exposure length: 2065 kJ/m2, black panel temperature 89 deg C.

Test Method: Once exposed, then check the stickness on the surface of the plaque by touching with index finger.

For the below example data, the following material formulations were used.

(A) Polypropylene

(BPP-1) Propylene-block-copolymer

MFR=53 g/10 min

23 deg C., nodecane insoluble weight: 12wt %

23 deg C., n□decane insoluble ethylene content: 37 mol %

23 deg C, n□decane insoluble [η]:7 dl/g

(BPP-2) Propylene-block-copolymer

MFR=100 g/10 min

23 deg C., n□decane insoluble weight: 7wt %

23 deg C, n□decane insoluble ethylene content: 37 mol %

23 deg C., n□decane insoluble [η]:7 dl/g

(BPP-3) Propylene-block-copolymer

MER-35 g/10 min

23 deg C., n□decane insoluble weight: 7wt %

23 deg C., n□decane insoluble ethylene content: 37 mol %

23 deg C, n□decane insoluble [η]:7 dl/g

(BPP-4) Propylene-block-copolymer

MFR=15 g/10 min

23 deg C., n□decane insoluble weight: 7wt %

23 deg C., n□decane insoluble ethylene content: 37 mol %

23 deg C., n□decane insoluble [η]:7 dl/g

(BPP-5) Propylene-block-copolymer

MFR=30 g/10 min

23 deg C., n□decane insoluble weight: 24wt %

23 deg C., n□decane insoluble ethylene content: 40 mol %

23 deg C., n□decane insoluble [η]: 2.5 dl/g

(HPP-1) Propylene-polymer

MFR=3 g/10 min

(BPP-2) Propylene-polymer

MFR=100 g/10 min

Ethylene-Alpha-olefin-diene-copolymer

(R-1) ethylene-propylene-diene-random-copolymer rubber

JSR.K.K, EP57P

MFR: 0.2 g/10 min

Ethylene-Alpha-olefin-octene-copolymer rubber

(R-3) ethylene-octane-random-copolymer rubber

Dupont, Engage8100

MFR: 2 g/10 min

(R-4) ethylene-octane-random-copolymer rubber

Dupont, Engage8150

MFR: 1 g/10 min

(R-6) ethylene-octane-random-copolymer rubber

Dupont, Engage8200

MFR: 10.6 g/10 min

(R-7) ethylene-octane-random-copolymer rubber

Dupont, Engage8180

MFR: 1 g/10 min

Ethylene-Alpha-olefin-copolymer

(R-2) ethylene-butane-random-copolymer rubber

Mitsui-chemical, TafinerA4050

MFR: 7 g/10 min

(C) Inorganic filler

Talc: Muramatsu-industry, 5000PJ

Average size: 4 micro meter

Modified polypropylene

(MPP-1) Maleic acid anhydride polypropylene (Sanyokasei,KK, U-mex1010, M=4.5)

(MPP-2)) Maleic acid anhydride polypropylene (Dupont Canada, Inc., MZ203, M=1.6)

(MPP-2) ) Maleic acid anhydride polypropylene (Exxon, Inc., Exxelor, M=3)

Surface treatment

Erucamide (Nihon-seika, Newtron S)

Other additive

Petroleum resin+EVA blend (STRUTOL, TR060)

The information included in tables 1 to 4 is material formulations of various polypropylene composites. Various additives include: as antioxidation additive, IRGANOX1010 (CIBA-specialty-chemicals) 0.1 wt %; as an anti-oxidation additive, IRGAFOS168 (CIBA-specialty-chemicals): 0.1 wt %; as an Anti-light additive, LA52 (ADEKA, 0.2wt %); as a slip additive, stearic acide calcium (Nihon-yushi): 0.1 wt %; asa pigment MB, PPCM 802Y-307 (Tokyo-ink): 3wt %. The various additives may be mixed together, blended by a henshell mixer, and extruded by twin-screw extruder (Nihonseitetsu TEX30a).

Extruding condition:

Barrel temp:200 deg C., screw 600 rpm, ratio:50 kg/hr.

Then plates for IZOD impact test were molded by injection molding.

Mold condition: Mold temp:220 Deg C., and tooling temp:40 Deg C.

With these plates, the appearance was tested. Results are in Table 1 to 4.

TABLE 1

| | | | Example 1 | Example 2 | Comparable 1 | Comparable 2 | Comparable 3 |
|---|---|---|---|---|---|---|---|
| Composition | (A)PP | | BPP(61) | BPP- | BPP-5(72) | BPP-2(42) | BPP-3(47) |
| of PP | | | | 2(53.75) | HPP-1(4) | HPP-2(15) | BPP-4(15) |
| | (B) | (B-1) | R-1(9.4) | R-1(10) | — | — | — |
| | | (B-2) | R-3(9.6) | R-3(14.75) | — | R-3(15) | R-4(15) |
| | | | | | | R-6(7) | |
| | | (B-3) | | | R-2(4) | | |

| | | | | | | |
|---|---|---|---|---|---|---|
| | (C)Filler | Talc(20) | Talc(21.5) | Talc(20) | Talc(19) | Talc(23) |
| | (D)Grafted PP | MPP-1(0.4) | MPP-2(0.5) | — | MPP-2(1.3) | MPP-3(0.6) |
| | (E)Surface treatment | Ercamide(0.55) | Ercamide(0.5) | — | Ercamide(0.5) | Ercamide(0.3) |
| | Agent | | | | | |
| | The others | — | — | — | — | EVA + petroriam |
| | | | | | | resin(0.25) |
| Physical | FM(MPa) | 2200 | 2050 | 2280 | 2030 | 2350 |
| Properties | Izod@23(J/m) | 220 | 250 | 195 | 185 | 230 |
| | Glass Haze(%) | 9.8 | 4.8 | 1.8 | 14.7 | 4.2 |
| Appearance | Milled Gloss | 40 | 46 | 80 | 60 | 51 |
| | Scratch Resistance 1 | 13 | 13 | 2 | 13 | 15 |
| | Scratch Resistance 2 | 0.8 | 1.0 | 2.0 | 1.0 | 0.4 |
| | Total Result of Scratch | ∘ | ∘ | x | ∘ | ∘ |
| | resistance | | | | | |

TABLE 2

| | | | Example 1 | Comparable 4 | Comparable 5 | Comparable 6 |
|---|---|---|---|---|---|---|
| Composition | (A)PP | | BPP(61) | BPP(61) | BPP-1(61) | BPP-1(61) |
| of PP | (B) | (B-1) | R-1(9.4) | R-1(3.4) | — | R-1(19) |
| | | (B-2) | R-3(9.6) | R-3(15.6) | R-3(19) | — |
| | | (B-3) | — | — | — | — |

| | | | | | |
|---|---|---|---|---|---|
| | (C)Filler | Talc(20) | Talc(20) | Talc(20) | Talc(20) |
| | (D)Grafted PP | MPP-1(0.4) | MPP-1(0.4) | MPP-1(0.4) | MPP-1(0.4) |
| | (E)Surface treatment | Ercamide(0.55) | Ercamide(0.55) | Ercamide(0.55) | Ercamide(0.55) |
| | Agent | | | | |
| | The others | — | — | — | — |
| Physical | FM(MPa) | 2200 | 2100 | 2200 | 2300 |
| Properties | Izod@23(J/m) | 220 | 240 | 160 | 55 |
| Appearance | Milled Gloss | 40 | 56 | 55 | 30 |
| | Scratch Resistance 1 | 13 | 13 | 10 | 10 |
| | Scratch Resistance 2 | 0.8 | 0.95 | 0.95 | 1.00 |
| | Total Result of Scratch | ∘ | ∘ | ∘ | ∘ |
| | resistance | | | | |

TABLE 3

| | | | Example 1 | Comparable 7 | Comparable 8 | Comparable 9 |
|---|---|---|---|---|---|---|
| Composition | (A)PP | | BPP-1(61) | BPP-1(61) | BPP-1(61) | BPP-1(61) |
| of PP | (B) | (B-1) | R-1(9.4) | R-1(9.4) | R-1(9.4) | R-1(9.4) |
| | | (B-2) | R-3(9.6) | R-3(9.6) | R-3(9.6) | R-3(9.6) |
| | | (B-3) | — | — | — | — |

| | | | | | |
|---|---|---|---|---|---|
| | (C)Filler | Talc(20) | Talc(20) | Talc(20) | Talc(20) |
| | (D)Grafted PP | MPP-1(0.4) | MPP-1(0.4) | — | — |
| | (E)Surface treatment | Ercamide(0.55) | — | Ercamide(0.55) | Ercamide(1.0) |
| | Agent | | | | |
| Physical | Glass Haze | 9.8 | 6.2 | 3.7 | 2.1 |
| Properties | | | | | |
| Appearance | Milled Gloss | 40 | 38 | 39 | 40 |
| | Scratch Resistance 1 | 13 | 5 | 7 | 7 |
| | Scratch Resistance 2 | 0.8 | 1.90 | 1.80 | 1.20 |
| | Total Result of Scratch | ∘ | x | x | x |
| | resistance | | | | |

TABLE 4

| | | | Example 1 | Example 3 | Example 4 | Comparable 8 |
|---|---|---|---|---|---|---|
| Composition | (A)PP | | BPP-1(61) | BPP-1(61) | BPP-1(61) | BPP-1(61) |
| of PP | (B) | (B-1) | R-1(9.4) | R-1(9.4) | R-1(9.4) | R-1(9.4) |
| | | (B-2) | R-3(9.6) | R-3(9.6) | R-3(9.6) | R-3(9.6) |
| | | (B-3) | — | — | — | — |

| | | | | | |
|---|---|---|---|---|---|
| | (C)Filler | Talc(20) | Talc(20) | Talc(20) | Talc(20) |
| | (D)Grafted PP | MPP-1(0.4) | MPP-3(0.3) | MPP-3(0.6) | — |
| | (E)Surface treatment | Ercamide(0.55) | Ercamide(0.55) | Ercamide(0.55) | Ercamide(0.55) |
| | Agent | | | | |
| Appearance | Milled Gloss | 40 | 41 | 39 | 39 |
| | Scratch Resistance 1 | 13 | 10 | 13 | 7 |
| | Scratch Resistance 2 | 0.8 | 1.2 | 1.0 | 1.8 |
| | Total Result of Scratch | ∘ | ∘ | ∘ | x |
| | resistance | | | | |

TABLE 5
Weathering Test

| | | | | | | | Comparable | Comparable |
|---|---|---|---|---|---|---|---|---|
| | | | Example 1 | Example 1′ | Comparable 1 | Comparable 2 | 2′ | 10 |
| Composition | (A)PP Resin | | BPP-2 | BPP-2 | BPP-5(72) | BPP-2(42) | BPP-2(42) | BPP-2(60) |
| | | | (53.75) | (53.75) | HPP-1(4) | HPP-2(15) | HPP-2(15) | HPP-1(4) |
| | (B)Rubber | (B-1) | R-1(10) | R-1(10) | — | — | — | — |
| | | (B-2) | R-3(14.75) | R-3(14.75) | — | R-3(15) | R-3(15) | R-7(18) |
| | | | | | | R-6(7) | R-6(7) | |
| | | (B-3) | — | — | R-2(4) | — | — | — |

| | (C)Filler | Talc(21.5) | Talc(21.5) | Talc(20) | Talc(19) | Talc(19) | Talc(18) |
|---|---|---|---|---|---|---|---|
| | (E)Surface treatment | Erucamide | Erucamide | 0 | Erucamide | Erucamide | Erucamide |
| | | (0.5) | (0.5) | | (0.5) | (0.5) | (0.5) |
| | (D)Grafted | MPP-2 | MPP-2 | 0 | MPP-2 | MPP-2 | MPP-2 |
| | Polypropylene | (0.75) | (0.75) | | (0.75) | (0.75) | (0.5) |
| UV glass(F) | | No | Yes | No | No | Yes | No |
| Appearance | Delta E | 0.90 | 0.78 | 0.40 | 1.30 | 0.98 | 1.34 |
| | Stickness | 3 | 4 | 5 | 2 | 3 | 2 |

*Stickness: 1(worse)-5(Better)

As can be seen from the above data in Table 1 and from examples 1 and 2 and Comparable 1 and 3, the scratch resistance in examples 1 and 2 is improved in comparison to the comparable examples 1 and 3. An appropriate amount of modified polypropylene and surface treatment improves the scratch resistance of the polypropylene composite. Additionally, it can be seen that inclusion of the B-1 and B-2 components in an appropriate amount provides a more desirable lower surface gloss.

The data provided in Table 2 and shown in example 1, and Comparable 4 to 6 demonstrates the improved Izod impact (at Room temp) in comparison to comparables 5 and 6. Additionally, example I displays an improved gloss in comparison to comparables 4 and 5. The inclusion of appropriate amounts of (B-1) and (B-2) allows for the combination of improved Izod impact and surface gloss.

The data provided in Tables 3 & 4 and as shown in Examples 1, 3 and 4, and Comparable 7 to 9 demonstrates the improved scratch resistance of the example materials. Inclusion of appropriate amounts of (D) and (E) improves the scratch resistance over the comparable materials.

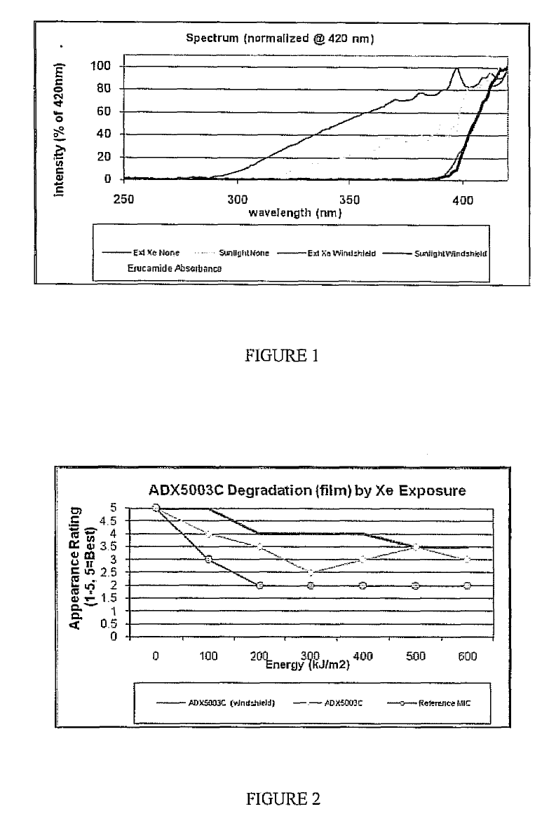

The data provided in Table 5 and in examples 1 and 1′ and in FIGS. 1 and 2, and Comparables 1, 2, 2′ and 10 demonstrates the improved weatherability resistance including stickness and discoloration of the materials in comparison to other composite materials having a surface treatment material included. As can be seen in the table examples 1 and 1′ exhibit improved delta E values and have lower stickness values in comparison to comparable materials that include a surface treatment material. The materials of examples 1 and 1′ do not bloom to provide a sticky surface layer when positioned under UV glass as occurs in the comparables.

Referring to FIG. 1, it can also be seen that the absorbance spectrum of one example of a surface treatment material, erucamide declines at around 350 nm. The absorbance of the sunlight and windshield curve that includes UV glass does not have an appreciable absorbance until around 380 nm, while the sunlight with no windshield has an absorbance beginning at around 300 nm. In this manner, UV glass may provide protection in the absorbance range of the surface treatment material at lower wavelengths to lessen the impact of UV radiation in comparison to an unprotected material. As seen in FIG. 2, the material with a UV glass windshield displays superior appearance ratings in comparison to an unprotected material and a prior art reference material.

1. A polypropylene composite comprising:
(A) 50 to 75 wt. % of polypropylene resin, based on the weight of the polypropylene composite, wherein the polypropylene resin has a melt flow rate of from 20 to 300 at 230 degrees centigrade under a 2.16 kg load;
(B1) 5 to 15 wt. % based on the weight of the polypropylene composite of ethylene-alpha-olefin diene copolymer rubber, wherein said ethylene-alpha-olefin diene copolymer rubber has a melt flow rate of less than 0.4 at 230 degrees centigrade under a 2.16 kg load;
(B2) 5 to 15 wt. % of an ethylene-alpha-octene copolymer rubber, wherein said ethylene-alpha-octene copolymer rubber resin has a melt flow rate of from 0.5 to 20 at 230 degrees centigrade under a 2.16 kg load wherein a ratio of B1 divided by B1 and B2 is from 0.35 to 0.45;
(C) 20 to 25 wt. % based on the weight of the polypropylene composite of inorganic filler;
(D) 0.1 to 5 wt % based on the weight of the polypropylene composite of grafted polypropylene; and
(E) 0.1 to 0.6 wt % based on the weight of the polypropylene composite of a surface treatment material wherein the surface treatment material remains dispersed in the polypropylene composite preventing blooming of the surface treatment material when exposed to the environment.

2. The polypropylene composite of claim 1 wherein the surface treatment material is present in an amount of from 0.1 to 0.5 weight percent based on the weight of the polypropylene composite.

3. The polypropylene composite of claim 1 wherein the polypropylene includes a polypropylene ethylene block copolymer.

4. The polypropylene composite of claim 3 wherein the polypropylene ethylene block copolymer has an n-deca insoluble wt range of from 5 to 15 weight percent.

5. The polypropylene composite of claim 1 wherein the ethylene-alpha-olefin diene copolymer rubber has a molecular weight of from 2.0×10⁵ to 5.0×10⁵.

6. The polypropylene composite of claim 1 wherein the alpha olefin of the ethylene-alpha-olefin diene copolymer rubber includes from 3 to 10 carbons.

7. The polypropylene composite of claim 6 wherein the alpha olefin of the ethylene-alpha-olefin diene copolymer rubber is selected from the group consisting of propylene, 1-butene, 1-hexene, and 1-octene.

8. The polypropylene composite of claim 1 wherein the diene of the ethylene-alpha-olefin diene copolymer rubber is selected from the group consisting of: 5-ethylidene-2-norbornene, 5-polypylidene-2-norbornene, dicylo-pentadiene, 5-vinyl-2-norbornadiene, 5-methylene-2-norbornadiene, cyclic-non-conjugated-dienes, 1,4-hexa-diene, 4-methyl-1,4-hexadiene, 5-methyl-1, 4hexadiene, 5-methyl-1,5-heptadiene, 6-methy-1, 5-heptadiene, 6-methyl-1, 7-octadiene, 7-methyl-1,6octadiene, and cyclic-conjugated-dienes.

9. The polypropylene composite of claim 1 wherein the ethylene-alpha-octene copolymer rubber has a molecular weight of from 1.0×10⁵ to 1.8×10⁵.

10. The polypropylene composite of claim 1 wherein the inorganic filler is selected from the group consisting of: talc, mica, calcium carbonate, barium sulfate, glass fiber, gypsum, magnesium carbonate, magnesium oxide, titanium oxide, iron oxide, zinc, copper, iron, aluminum and other metal powders, and inorganic fibers.

11. The polypropylene composite of claim 10 wherein the talc has an average diameter ranging from 1 to 15 μm.

12. The polypropylene composite of claim 1 wherein the grafted polypropylene includes a hydride acid.

13. The polypropylene composite of claim 12 wherein the hydride acid is maleic anhydride.

14. The polypropylene composite of claim 13 wherein the maleic anhydride is present in an amount of from 0.8 to 2.0 weight percent based upon a total weight of the polypropylene composite.

15. The polypropylene composite of claim 1 wherein the surface treatment includes a fatty acid amide.

16. The polypropylene composite of claim 15 wherein the fatty acid amide is selected from the group consisting of: oleic amide, stearic amide, erucic amide, behenic amide, palmitic amide, myrystic amide, lauric amide, caprylic amide, n-oreic-parmit-amide, n-oreic-eruic amide or combinations thereof.

17. The polypropylene composite of claim 15 wherein the fatty acid amide is present in an amount of from 0.3 to 0.5 weight percent based upon a total weight of the polypropylene composite.

18. The polypropylene composite of claim 1 wherein the composite material is formed into a component that is positioned proximate to UV glass.
